(19) United States
(12) Patent Application Publication
(10) Pub. No.: US 2010/0295823 A1
(43) Pub. Date: Nov. 25, 2010

(54) APPARATUS FOR TOUCHING REFLECTION IMAGE USING AN INFRARED SCREEN

(75) Inventors: Yang Keun Ahn, Seoul (KR); Kwang Mo Jung, Seoul (KR); Young Choong Park, Seoul (KR); Kwang Soon Choi, Goyang-si (KR); Woo Chool Park, Incheon (KR); Hae Moon Seo, Yongin-si (KR)

Correspondence Address: North Star Intellectual Property Law, PC, P.O. Box 34688, Washington, DC, 20043, US

(73) Assignee: Korea Electronics Technology Institute, Seongnam-city (KR)

(21) Appl. No.: 12/726,870

(22) Filed: Mar. 18, 2010

(30) Foreign Application Priority Data
May 25, 2009 (KR) 10-2009-0045382

(51) Int. Cl. G06F 3/042

(52) U.S. Cl. 345/175

(57) ABSTRACT

An apparatus for touching a reflection image using an infrared screen, more particularly to an apparatus for touching a reflection image using an infrared screen comprising infrared LEDs, an infrared camera, and a projector for projecting an image in free space so as to implement a virtual touch screen in free space.

The apparatus for touching a reflection image using an infrared screen includes: an infrared LED array configured to generate infrared rays and creates an infrared screen in free space, an infrared camera installed such that the lens is directed toward the infrared screen, a projector configured to project an image into the infrared screen, and a space touch sensing module configured to sense a touch location on the infrared screen where user's pointing means is touched using the gray scale image captured by the infrared camera.

### CROSS-REFERENCE TO RELATED APPLICATIONS

This application claims the benefit under 35 U.S.C. §119(a) of a Korean Patent Application No. 10-2009-0045382 filed with the Korean Intellectual Property Office on May 25, 2009, the entire disclosure of which is incorporated herein by reference for all purposes.

### TECHNICAL FIELD

The following description relates to an apparatus for touching a reflection image using an infrared screen, more particularly to an apparatus for touching a reflection image using an infrared screen comprising infrared LEDs, an infrared camera, and a projector for projecting an image in free space so as to implement a virtual touch screen in free space.

### BACKGROUND

Recently, touch screens enabling direct input on a screen without using a keyboard are widely used so as to perform a specific process by an embedded software according to the corresponding location when a hand or an object touches a character or a specific area on the screen.

Since a touch screen can display various characters and pictures representing user functions, a user function can be easily recognized. Therefore, touch screens are utilized diversely, as implemented in an information terminal, a vending machine, and a general office machines etc., at a location such as a subway, a department store, or a bank.

As shown in FIG. 1, a conventional touch screen senses a user input by recognizing a change in the characteristics of the corresponding area when a fingertip or an object touches a certain area of a monitor screen on which a touch panel is laminated.

A conventional touch screen analyzes a touch location by dividing the entire screen into a two dimensional grid form. This is an interface method utilizing sensing means such as a capacitance, a ultrasonic wave, an infrared rays, a resistive film, or a sound wave.

### SUMMARY

Since a conventional touch screen is configured as a two dimensional form where a display screen and a touch panel are located on a same plane, a virtual touch screen that touches free space apart from the display can not be realized.

The above-described problems with the related art are solved by embodiments, and accordingly an object thereof is to provide an apparatus for touching a reflection image using an infrared screen; it projects an image into free space, recognizes user's touch location as to the projected image, and executes a user command based on the recognized touch location.

To achieve above-described object, an apparatus for touching a reflection image using an infrared screen includes: an infrared LED array configured to generate infrared rays and creates an infrared screen in free space, an infrared camera installed such that the lens is directed toward the infrared screen, a projector configured to project an image into the infrared screen, and a space touch sensing module configured to sense a touch location on the infrared screen where user's pointing means is touched using the gray scale image captured by the infrared camera.

The projector may further include a display module and a projection module configured to project an image displayed on the display module into the infrared screen.

The projection module may further include: a beam splitter configured to split an emitting beam from the display module into two beams; a spherical minor configured to reflect a beam, originally generated from the display module and reflected from the beam splitter, back toward the beam splitter; and a polarization filter configured to convert the beam from the spherical mirror passing through the beam splitter into a polarized beam.

The polarization filter may convert the beam, reflected from the spherical mirror and passing through the beam splitter, into a circularly polarized beam.

The space touch sensing module may further include: a binarization unit configured to binarize a gray scale image captured by the infrared camera; a smoothing unit configured to smooth out an image binarized by the binarization unit; a labeling unit configured to label a smoothed binarized image smoothed out by the smoothing unit; and a coordinate calculation unit configured to calculate a set of central coordinates of a blob having values exceeding a predetermined binary threshold value among the blobs labeled by the labeling unit.

An apparatus for touching a reflection image using an infrared screen provides a realistic interactive user interface, and provides a user with amusement and convenience. In near future, the kiosks adopting the concept of embodiments may use such realistic user interfaces.

### BRIEF DESCRIPTION OF THE DRAWINGS

FIG. 1 is a block diagram of a conventional touch screen apparatus.

FIGS. 2 and 3 are block diagrams of an apparatus for touching a reflection image using an infrared screen in accordance with an embodiment.

FIG. 4 is an illustration explaining the theory of sensing a space touch in an infrared screen method in accordance with an embodiment.

FIG. 5 is a flow diagram explaining the method of sensing a space touch using an apparatus for touching a reflection image using an infrared screen in accordance with an embodiment.

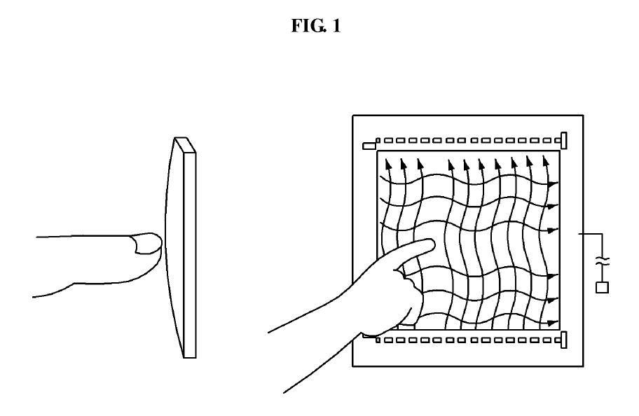

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of well-known functions and constructions may be omitted for increased clarity and conciseness.

An apparatus for touching a reflection image using an infrared screen will be described in detail with reference to the attached drawings based on an example embodiment.

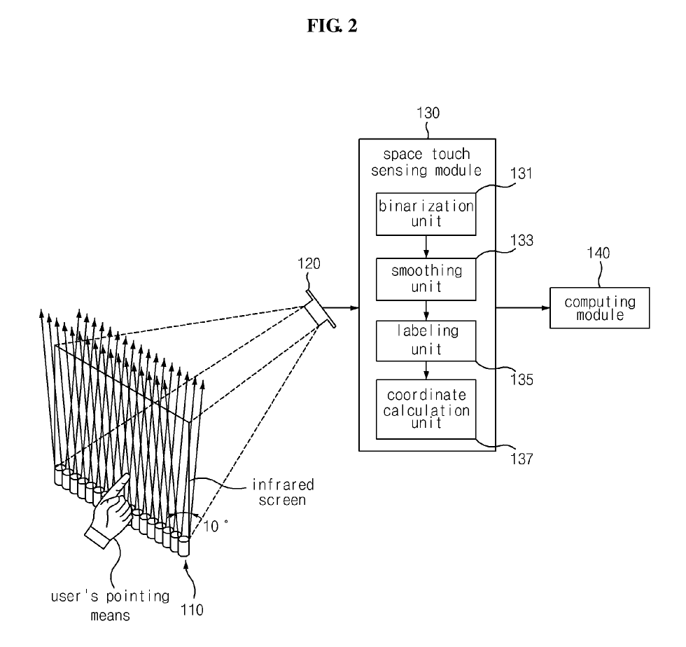

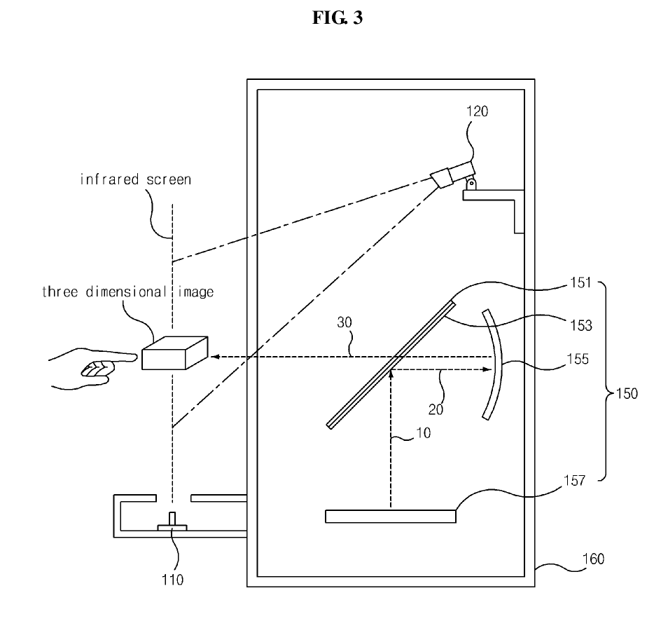

FIGS. 2 and 3 are block diagrams of an apparatus for touching a reflection image using an infrared screen in accordance with an example embodiment.

As shown in FIGS. 2 and 3, an apparatus for touching a reflection image using an infrared screen includes: an infrared LED array 110 configured to generate infrared rays and creates an infrared screen in free space, an infrared camera 120 installed such that the lens is directed toward the infrared screen, a projector 150 configured to project an image into the infrared screen, a space touch sensing module 130 configured to sense a touch location on the infrared screen where user's pointing means, such as a fingertip or a touch pen, is touched using the gray scale image captured by the infrared camera 120, and a housing 160 for mounting such components.

The infrared screen generated by the infrared LED array 110 may be a virtual touch screen formed in a free space. The width of the infrared LED may be determined by the numbers of the LEDs arranged in a serial fashion.

A rectangular shaped frame may be formed around the perimeter of the infrared screen such that a user can easily recognize the outline of the infrared screen. In this case, the infrared LED array 110 can be installed anywhere at the upper, bottom, left, or right end of the frame.

The infrared LED array 110 may include infrared LEDs having narrow beam angle. In other words, the beam angle of the infrared LED array 110 may be less than 10 degrees.

The infrared camera 120, wherein a filter may be installed to cut off the visual light while passing infrared rays, blocks the visual light radiating from the indoor fluorescent light bulbs and the three dimensional image projected into the infrared screen, but may pass infrared rays so as to capture the infrared rays as a gray scale image. The infrared camera 120 may be installed facing a user to capture the infrared screen.

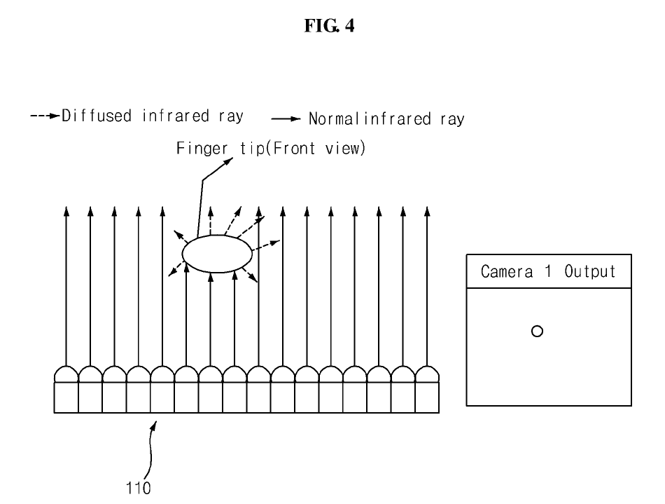

FIG. 4 is an illustration explaining the theory of sensing a space touch in an infrared screen method in accordance with an embodiment.

An image captured by the infrared camera 120 may be dark black due to the infrared rays emitted from the infrared LED array 110 until a user's pointing means enters into the infrared screen.

When a user's pointing means enters into the infrared screen, a scattering or diffusing of the infrared rays may occur at the point so that the area where the user's pointing means are located appears to be bright, as illustrated in FIG. 4. Eventually, the X and Y coordinates of a space touch location on the infrared screen can be determined by calculating the central point through an image processing of the bright spot.

The projector 150 may include a display module 157 to display an image and a projection module to project the displayed image into the infrared screen as disclosed in U.S. Pat. No. 6,808,268, which is incorporated herein by reference in its entirety.

The display module 157 may further include a high bright LCD (HLCD).

The projector 150 may include a polarization filter 151, a beam splitter 153, and a spherical mirror 155.

The polarization filter 151, installed slantly above the screen of the display module 157, may convert a beam, reflected from the spherical mirror 155 and passing through the beam splitter 153, into a polarized beam 30 to project into the infrared screen.

The polarization filter 151 can also be realized using a circularly polarized light (CPL) filter configured to convert a beam, reflected from the spherical mirror 155 and passing through the beam splitter 153, into a circularly polarized light.

The beam splitter 153, installed between the display module 157 and the polarization filter 151 in parallel with the polarization filter 151, may split a beam 10 emitting from the display module 157 into two beams: an object beam and a reference beam which is reflected from the beam splitter 153.

The spherical mirror 155, located along the propagating direction of the reference beam 20 which is reflected from the beam splitter 153, may reflect the reference beam 20, emitted from the display module 157 and reflected from the beam splitter 153, toward the beam splitter 153.

The spherical mirror 155 can also be realized using a concave mirror as illustrated in FIG. 3.

The space touch sensing module 130 may include a binarization unit 131, a smoothing unit 133, a labeling unit 135, and a coordinate calculation unit 137.

The binarization unit 131 may binarize a gray scale image captured by the infrared camera 120. More specifically, the binarization unit 131 may perform binarization by adjusting pixel values lower than the predetermined binary threshold value to “0” (e.g., black) and pixel values higher than the predetermined binary threshold value to “255” (e.g., white) based on the gray scale image which is captured by the infrared camera 120.

The smoothing unit 133 may remove noise from the binarized image by smoothing the image binarized by the binarization unit 131.

The labeling unit 135 may perform labeling for the binarized image which is smoothed by the smoothing unit 133. More specifically, the labeling unit 135 may label for the pixels whose pixel values are adjusted to “255.” For example, the labeling unit 135 reorganizes a binary image by assigning different number for each white blob using 8neighbor pixel labeling technique.

The coordinate calculation unit 137 may calculate a set of central coordinates of a blob having higher value than the predetermined binary threshold value among the blobs labeled by the labeling unit 135. More specifically, the coordinate calculation unit 137 may calculate a set of central coordinates of the corresponding blob assuming that a blob having higher value than the binary threshold value is equivalent to a finger or an object in contact with the infrared screen. Central coordinates can be determined by using various techniques. For example, the coordinate calculation unit 137 may take medium values between the minimum and maximum values of X and Y as a center of gravity to determine the corresponding coordinates.

The coordinate calculation unit 137 may calculate the central coordinates only for the largest blob when there are multiple blobs having higher value than the binary threshold value.

An apparatus for touching a reflection image using an infrared screen may further include a computing module 140 to perform functions corresponding to the position information recognized by the space touch sensing module 130.

More specifically, when the space touch sensing module 130 outputs a position information, the computing module 140 may recognize this position information as a selection of a function and may execute this selected function, for example, the display screen can be switched.

The computing module 140 may be connected to external devices through a cable or wireless network. Therefore, above described external devices can be controlled using a position information recognized by the space touch sensing module 130. In other words, if the position information corresponds to a control command for an external device, the corresponding function may be performed by the external device, wherein the external devices can be a home network appliance and server connected through the network.

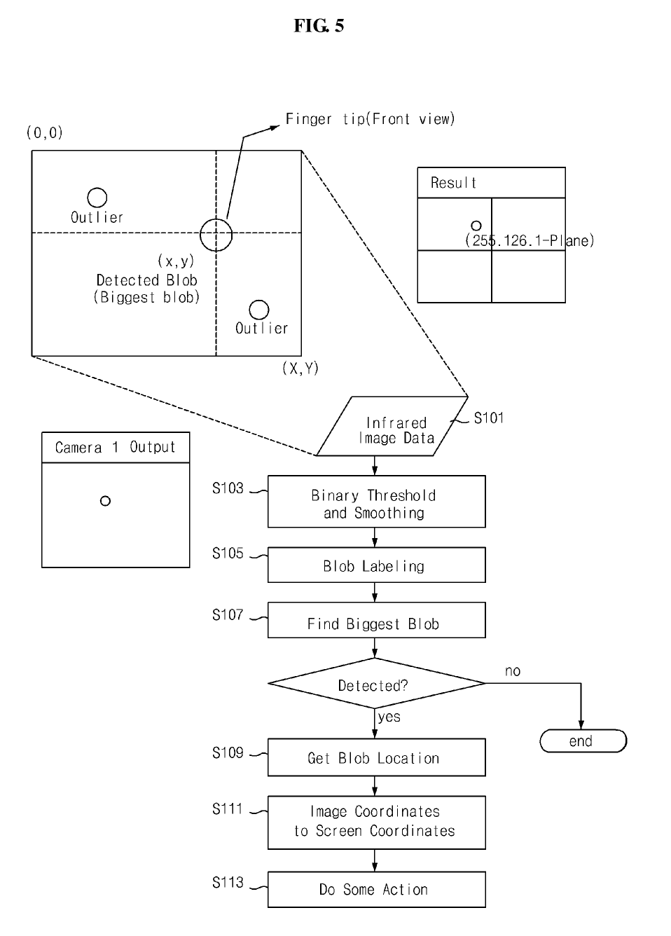

FIG. 5 is a flow diagram explaining the method of sensing a space touch using an apparatus for touching a reflection image using an infrared screen in accordance with an example embodiment.

At first, the space touch sensing module 130 may receive a gray scale image from the infrared camera 120 at step S101 to perform binarizing and smoothing of the gray scale image at step S103 as shown in FIG. 5. Then labeling of the binarized gray scale image may be performed at step S105, and a blob corresponding to a user's pointing means (e.g., fingertip) may be selected among the labeled blobs at step S107.

If a blob corresponding to a user's pointing means (e.g., fingertip) is detected, the central coordinates of the corresponding blob may be calculated at step S109, and the calculated central coordinates may be converted into a central coordinates of the infrared screen and transmitted to the computing module 140 at step S111.

Finally, the computing module 140 may perform a function corresponding to the position information recognized by the space touch sensing module 130 at step S113.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for touching a reflection image using an infrared screen comprising:
an infrared LED array configured to:
generate infrared rays; and
create an infrared screen in free space;
an infrared camera comprising a lens directed toward the infrared screen, the infrared camera configured to photograph the infrared screen;
a projector configured to project an image into the infrared screen; and
a space touch sensing module configured to sense the touched location on the infrared screen touched by a user's pointing means using a gray scale image captured by the infrared camera.

2. The apparatus for touching a reflection image using an infrared screen of claim 1, wherein the projector further comprises:
a display module configured to display images; and
a projection module configured to project the images displayed on the display module into the infrared screen.

3. The apparatus for touching a reflection image using an infrared screen of claim 2, wherein the projection module further comprises:
a beam splitter dividing a beam emitted from the display module into two beams; and
a spherical mirror configured to reflect a beam, originally generated from the display module and reflected from the beam splitter, back toward the beam splitter.

4. The apparatus for touching a reflection image using an infrared screen of claim 3, wherein the projection module further comprises a polarization filter configured to convert the beam from the spherical mirror passing through the beam splitter into a polarized beam.

5. The apparatus for touching a reflection image using an infrared screen of claim 4, wherein the polarization filter is further configured to convert a beam, reflected from the spherical mirror and passing through the beam splitter, into a circularly polarized beam.

6. The apparatus for touching a reflection image using an infrared screen of claim 1, wherein the space touch sensing module further comprises:
a binarization unit configured to binarize a gray scale image captured by the infrared camera;
a smoothing unit configured to smooth out an image binarized by the binarization unit;
a labeling unit configured to label a smoothed binarized image smoothed out by the smoothing unit; and
a coordinate calculation unit configured to calculate a set of central coordinates of a blob having values exceeding a predetermined binary threshold value among the blobs labeled by the labeling unit.

7. The apparatus for touching a reflection image using an infrared screen of claim 2, wherein the space touch sensing module further comprises:
a binarization unit configured to binarize a gray scale image captured by the infrared camera;
a smoothing unit configured to smooth out an image binarized by the binarization unit;
a labeling unit configured to label a smoothed binarized image smoothed out by the smoothing unit; and
a coordinate calculation unit configured to calculate a set of central coordinates of a blob having values exceeding a predetermined binary threshold value among the blobs labeled by the labeling unit.

8. The apparatus for touching a reflection image using an infrared screen of claim 3, wherein the space touch sensing module further comprises:
a binarization unit configured to binarize a gray scale image captured by the infrared camera;
a smoothing unit configured to smooth out an image binarized by the binarization unit;
a labeling unit configured to label a smoothed binarized image smoothed out by the smoothing unit; and
a coordinate calculation unit configured to calculate a set of central coordinates of a blob having values exceeding a predetermined binary threshold value among the blobs labeled by the labeling unit.

9. The apparatus for touching a reflection image using an infrared screen of claim 4, wherein the space touch sensing module further comprises:
a binarization unit configured to binarize a gray scale image captured by the infrared camera;
a smoothing unit configured to smooth out an image binarized by the binarization unit;
a labeling unit configured to label a smoothed binarized image smoothed out by the smoothing unit; and
a coordinate calculation unit configured to calculate a set of central coordinates of a blob having values exceeding a predetermined binary threshold value among the blobs labeled by the labeling unit.

10. The apparatus for touching a reflection image using an infrared screen of claim 5, wherein the space touch sensing module further comprises:
a binarization unit configured to binarize a gray scale image captured by the infrared camera;
a smoothing unit configured to smooth out an image binarized by the binarization unit;
a labeling unit configured to label a smoothed binarized image smoothed out by the smoothing unit; and
a coordinate calculation unit configured to calculate a set of central coordinates of a blob having values exceeding a predetermined binary threshold value among the blobs labeled by the labeling unit.
